(19) United States
(12) Patent Application Publication
(10) Pub. No.: US 2007/0024668 A1
(43) Pub. Date: Feb. 1, 2007

(54) Ink jet printer having print bar with spaced print heads

(75) Inventor: Jeffrey J. Folkins, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/191,313

(22) Filed: Jul. 28, 2005

(51) Int. Cl. B41J 2/21; B41J 2/01

(52) U.S. Cl. 347/43; 347/103; 347/104

(57) ABSTRACT

An ink jet printer has a drum rotated about its axis and past a translatable print bar located adjacent and parallel thereto. The print bar has equally spaced, identical print heads mounted along the length thereof to print images on the drum or directly on a recording medium mounted on the drum. Each print head has an array of high density nozzles that extend for a predetermined length. The spacing between print heads is equal to the integer multiples of the nozzle array length. The print bar may be translated a distance equal to a integer divisor of the nozzle array length up to one full nozzle array length during each drum revolution. The drum rotation and concurrent print bar translation produce barber pole shaped swaths of image on the drum by each print head. Multiple passes of the drum are required to print a complete image.

### BACKGROUND

An exemplary embodiment of this application relates to an ink jet printer having a translating print bar with spaced print heads thereon that print on a rotating image receiving surface. More particularly, the exemplary embodiment relates to an ink jet printer having a translating print bar with a plurality of equally spaced print heads thereon. Each of the print heads eject ink droplets onto the surface of a rotating image receiving cylindrical surface as the print bar is translated to produce barber pole shaped swaths of an image on the cylindrical surface. After multiple passes of the cylindrical surface past the translating print bar, a complete image is printed thereon. The cylindrical surface may be a recording medium, such as paper, held on a drum or an intermediate transfer drum.

Droplet-on-demand ink jet printing systems eject ink droplets from print head nozzles in response to pressure pulses generated within the print head by either piezoelectric devices or thermal transducers, such as resistors. The ejected ink droplets are propelled to specific locations on a recording surface, commonly referred to as pixels, where each ink droplet forms a spot thereon. The print heads have arrays of droplet ejecting nozzles and a plurality of ink containing channels, usually one channel for each nozzle, which interconnect an ink reservoir in the print head with the nozzles.

In a typical piezoelectric ink jet printing system, the pressure pulses that eject liquid ink droplets are produced by applying an electric pulse to the piezoelectric devices, one of which is typically located within each one of the ink channels. Each piezoelectric device is individually addressed to cause it to bend or deform and pressurize the volume of liquid ink in contact therewith. When a voltage pulse is applied to a selected piezoelectric device, a quantity of ink is displaced from the ink channel and a droplet of ink is mechanically ejected from the nozzle associated with that piezoelectric device. Just as in thermal ink jet printing, the ejected droplets are propelled to pixel targets on a recording surface to form an image of information thereon. The respective channels from which the ink droplets were ejected are refilled by capillary action from an ink supply. For an example of a piezoelectric ink jet printer, refer to U.S. Pat. No. 6,739,690 or U.S. Pat. No. 3,946,398.

The problem of ink drying time and paper cockling are widely recognized issues when printing high coverage areas with aqueous based inks, particularly when printing color images. The problem of drying time and paper cockling is substantially reduced when solid ink printers are used and their print heads eject droplets of melted ink onto the recording surface, where the melted ink droplets solidify immediately. Improvements in image quality and latitude are obtained when the print head ejects droplets of melted ink onto an intermediate surface, such as, for example, the surface of an intermediate transfer drum, that has a release agent coating thereon. Once the image is formed on the intermediate transfer drum, the image is then transferred to a recording medium, such as paper. The transfer is generally conducted in a nip formed by the rotating intermediate transfer drum surface and a rotatable pressure roll. The pressure roll may be heated or the recording medium may be pre-heated prior to entry in the transfixing nip. As a sheet of paper is transported through the nip, the fully formed image is transferred from the intermediate transfer drum surface to the sheet of paper and concurrently fixed thereon. This transfer technique of using the combination of heat and pressure at a nip to transfer and fix the image to a recording medium passing through the nip is usually referred to as “transfixing,” a well known technology.

Conventionally, there are two classes of multi-pass ink jet printing architectures; viz., one using a partial width print head for scanning and the other using a full width print head for scanning. Partial width print heads generally require that the print head remain stationary while printing a swath of image during each pass of a recording medium held on a rotating drum or a rotating intermediate transfer drum. After each swath of image is printed, the print head is stepped a distance at most equal to the width of the printed swath on the recording medium or surface of the intermediate transfer drum. The printing and stepping continues until the complete image has been printed. In contrast, the full width array print heads remain stationary as the recording medium or intermediate transfer drum is rotated there past. The full width array print heads offer advantages over partial width scanning arrays, for there is no need for a scanning carriage to travel a large distance and, since there is no stepping required, there is no loss of printing productivity that is associated with print head stepping.

Some current solid ink jet type printers generally use multiple passes of a full width print head having low nozzle densities to print on a rotating intermediate transfer drum. By utilizing a single full width array print head, but of limited nozzle density, the full width array print head is required to translate only a small distance along the length of the intermediate transfer drum for each pass of the intermediate transfer drum. Such an architecture is efficient in that it allows for image printing with little lost of printing productivity, except, of course, for the subsequent transfer step upon completion of the printed image.

The full width print head of such known ink jet printers may print pixel columns of information circumferentially on the intermediate transfer drum. After each printed pixel column, the full width print head may be stepped axially to the drum axis for printing subsequent adjacent columns until the entire image is completed. Some printing productivity is lost during the required print head stepping.

Print heads having piezoelectric devices suitable for solid ink printing may now be available in small dies or MEMS devices with high nozzle densities, such as, for example, nozzle arrays capable of printing 400 to 450 spots per inch (spi). However, a difficulty is encountered when trying to take advantage of this high density printing capability in a low cost office printer. For example, a full width print head composed of abutted dies or MEMS devices with nozzles spaced for printing at 400 to 450 spi, would have increased printing speed and resolution. However, the large increase in the number of nozzles required for a full width print head would also reduce print head reliability and greatly increase the print head cost. Accordingly, the trade off of using a full width print head having high density nozzle arrays in a solid ink jet printer instead of a more reliable, lower resolution full width print head is much less desirable when cost and reliable are a factor.

In one known solid ink jet printer, the transfixing roll is spaced from the intermediate transfer drum and is moved to produce a nip with the intermediate drum only after the complete image has been printed on the intermediate drum and the intermediate transfer drum is stopped. Before the nip is formed, the leading edge of a recording medium is transported into the transfixing nip region. Therefore, the transfixing roll engages the leading edge of the recording medium and sandwiches it between the transfixing roll and the intermediate drum. Once the nip is formed, the transfixing roll and intermediate drum are rotated to transport the recording medium through the transfixing nip and concomitantly transfixing the image to it. Conversely, the transfixing roll is disengaged from the trailing edge of the recording medium before the recording medium leaves the transfixing nip.

Examples of ink jet printers having full width array print heads and/or an intermediate transfer drum from which printed images are transferred to a recording medium at a transfixing station are disclosed below.

U.S. Pat. No. 5,099,256 discloses a thermal ink jet printer having a translatable multicolor printhead and a rotatable intermediate drum with a film forming silicone polymer layer on the outer surface thereof. The drum surface is heated to dehydrate the aqueous based ink droplets deposited thereon from the printhead at a first location. The drum is rotated and the dehydrated droplets are transferred from the drum to a recording medium at a transfer station positioned adjacent the drum at a second location.

U.S. patent application Ser. No. 11/040,040, filed Jan. 21, 2005, discloses an ink jet printer having a print head that moves in a two dimensional direction across the surface of a moving intermediate drum or belt. During the printing process, the print head is concurrently moved in a first direction at a velocity equal to the velocity and direction of the intermediate surface and in a second direction that is perpendicular to the first direction. This two dimensional movement of the print head causes the ink droplets to print swaths of information across the intermediate surface that are perpendicular to the first direction. Downstream from the print head, the printed information is transferred and fixed to a recording medium as it is transported through the transfixing nip at the transfixing station.

U.S. patent application Ser. No. 10/974,768, filed Oct. 28, 2004 (Attorney Docket No. A3079-US-NP), discloses an ink jet printer having a print head, intermediate drum, and transfixing station. Test images are formed on the inter-document space or blank portions of the intermediate drum by those nozzles of the print head that are most likely to be defective. Thus, the time and ink required to form the test images with nozzles unlikely to be defective is not wasted. The test images printed by the potentially defective nozzles are tested using an image sensor.

U.S. patent application Ser. No. 11/120,343, filed May 3, 2005 (Attorney Docket No. 20040643-US-NP), discloses an ink jet printer having an intermediate transfer drum that rotates past a print head and a downstream transfixing station. The transfixing station has separate simplex and duplex operating modes. A movable transfixing roll at the transfixing station forms a nip with the intermediate transfer drum with different timing relationships as the recording medium approaches the nip, depending upon whether the image to be transfixed is a simplex or duplex print.

U.S. Pat. No. 4,829,324 discloses a large width array thermal ink jet print head that is assembled from generally identical print head sub-units. The sub-units eject ink droplets from nozzles on a side edge thereof and are generally referred to as edge shooters. The sub-units are aligned and bonded end-to-end on a strengthening substrate. U.S. Pat. No. 5,198,054 discloses a process for fabricating a page width print head from small edge shooter type print head sub-units. U.S. Pat. No. 5,160,945 discloses a page width thermal ink jet print head that is assembled from fully functional roof shooter type print head sub-units. The sub-units are fixedly mounted on an edge of a structural bar to minimize print head warping. A passageway in the structural bar edge provides the ink supply to each of the print head sub-units.

U.S. Pat. No. 5,257,043 discloses a large width array of individual thermal ink jet print head sub-units on a support bar. A series of the print head sub-units are spaced apart from each other by equal distances on both sides of the support bar. The series on each side of the support bar are in a staggered relationship to each other. Each print head sub-unit is mounted so that it can be replaced. U.S. Pat. No. 5,221,397 discloses a full width array thermal ink jet print head assembled from print head sub-units. The print head sub-units are assembled in an alignment fixture and then a structural bar is aligned and bonded to the assembled sub-units before the full width array print head assembly is removed from the alignment fixture.

### SUMMARY

According to aspects illustrated herein, there is provided an ink jet printer having a cylindrical, image-receiving surface rotated about its axis and a translatable print bar mounted adjacent and parallel thereto. The print bar has equally spaced, identical print heads mounted along the length of the print bar. The print heads eject ink droplets onto the rotating image receiving surface as the print bar is translated relative thereto, thereby printing swaths of information thereon in a barber pole fashion. Each print head has an array of nozzles with a predetermined length. The spacing between print heads on the print bar are equal to integer multiples of the length of a nozzle array as measured between nozzle arrays. The print bar may be translated the distance of from an integer divisor of the nozzle array length up to the distance of one nozzle array length during each revolution of the image-receiving surface. Thus, each print head prints a barber pole shaped swath of image on the image-receiving surface. The print head spacing on the print bar along with the desired image resolution in terms of spots per inch determines the number of drum revolutions required for completing the printed image. The cylindrical surface may be a receiving medium, such as paper, held on a cylindrical member or an intermediate transfer drum. Once the complete image is formed, the recording medium is removed from the drum or a movable transfixing roll is brought into contact with the intermediate transfer drum to form a transfixing nip through which a recording medium is transported.

In one aspect of the exemplary embodiment, there is provided a method of printing by an ink jet printer of the type having a print bar and a rotary image receiving member, comprising: providing a cylindrical image receiving surface having an axis; providing an elongated print bar adjacent said drum and parallel to said image receiving surface; equally spacing high resolution print heads in at least one row along said print bar, each of said print heads having an array of droplet ejecting nozzles that extend for a predetermined length, said print head spacing being integer multiples of a distance equal to said nozzle array length as measured between nozzle arrays of said print heads; rotating said image receiving surface about its axis; translating said elongated print bar in a direction parallel to said axis of said image receiving surface and at a speed capable of moving said print bar a predetermined distance during each revolution of said image receiving surface; and ejecting ink droplets from said print heads on said translating print bar onto said rotating image receiving surface, so that a swath of image information is printed on said image receiving surface in a barber pole fashion by each print head during each revolution of the image receiving surface.

### BRIEF DESCRIPTION OF THE DRAWINGS

An exemplary embodiment of this application will now be described, by way of example, with reference to the accompanying drawings, in which like reference numerals refer to like elements, and in which:

FIG. 1 is a schematic, side elevation view of an ink jet printer having a print bar, rotary image receiving member, and transfixing station containing a movable, nip-forming transfixing roll;

FIG. 2 is a partially shown top view of FIG. 1 showing the location of the spaced print heads on the print bar relative to the image receiving member prior to the initiation of printing;

FIG. 3 is a view similar to FIG. 2, but showing the print bar translation and the barber pole shaped swath of information printed on the drum by each of the print heads on the print bar after one revolution of the image receiving member;

FIG. 4 is a partially shown back view of the printer as indicated by view line 4-4 in FIG. 1, showing the print bar translation and the barber pole shaped swaths of information printed on the drum by the print heads after one revolution of the image receiving member;

FIG. 5 shows an isometric view of the image receiving member of FIG. 3 with the barber pole shaped swaths of information printed thereon and with the print head locations indicated in dashed line;

FIG. 6 is a partially shown print bar as viewed along view line 6-6 in FIG. 1, showing the print head and nozzle array lengths and print head spacing;

FIG. 7 is a schematic, side elevation view of an alternate embodiment of the ink jet printer shown in FIG. 1;

FIG. 8 is a partially shown schematic, side elevation view of the ink jet printer of FIG. 1, showing an alternate embodiment of the print bar that is capable of multi-color printing; and

FIG. 9 is a partially shown print bar as viewed along view line 9-9 in FIG. 8, showing a series of print heads aligned in columns, each capable of printing with a different color ink.

### DESCRIPTION OF THE PREFERRED EMBODIMENT

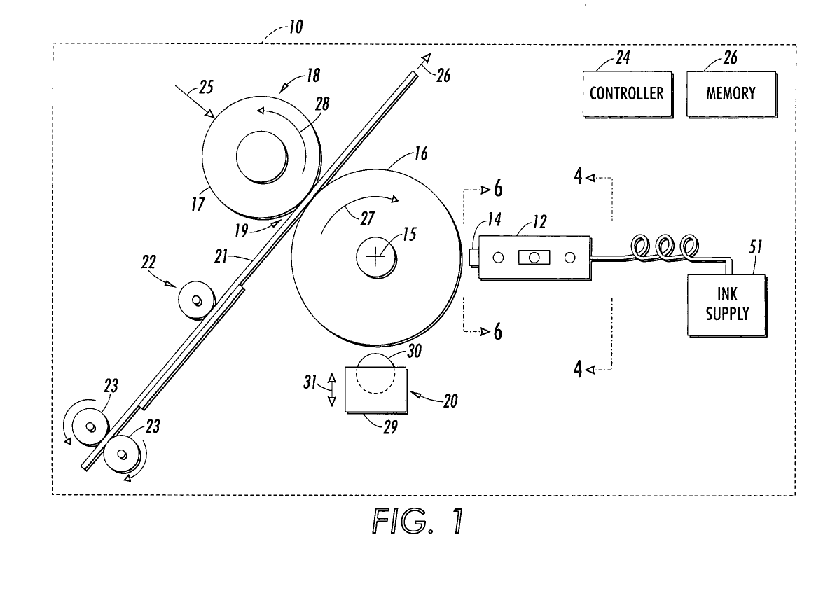

For a general understanding of an ink jet device, such as, for example, a solid ink jet printer in which the features of the exemplary embodiment of this application are incorporated, reference is made to FIG. 1. As shown in FIG. 1, the ink jet printer 10 includes, in part, a translatable print bar 12, a plurality of equally spaced print heads 14 mounted on the print bar, a rotary image receiving member in the form of an intermediate transfer drum 16, a transfixing station 18 having a movable transfixing roll 17, a release agent applicator 20, a recording medium transport 22 with a pair of pre-heating rolls 23, a controller 24 and a memory 26.

The memory 26 may include, for example, any appropriate combination of alterable, volatile or non-volatile memory, or non-alterable or fixed memory. The alterable memory, whether volatile or non-volatile, can be implemented using any one or more of static or dynamic RAM, a disk drive, a writeable or re-writeable optical disk and disk drive, a hard drive, flash memory or the like. Similarly, the non-alterable or fixed memory can be implemented using any one or more of ROM, PROM, EPROM, EEPROM, an optical ROM, such as CD-ROM or DVD-ROM disk, and disk drive or the like. It should also be appreciated that the controller 24 and/or memory 26 may be a combination of a number of component controllers or memories all or part of which may be located outside the printer 10.

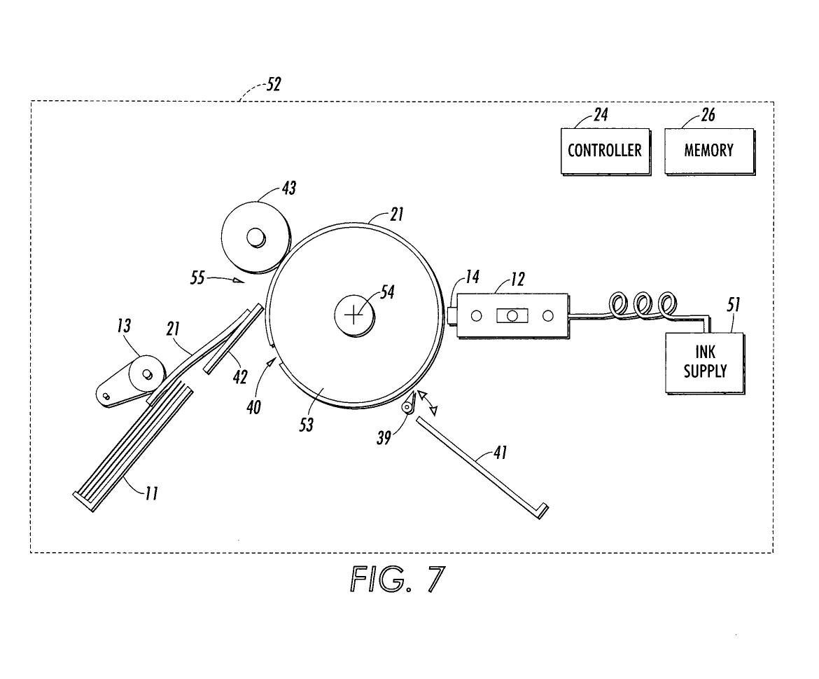

The solid ink jet printer 10 shown in FIG. 1 is a schematic side elevation view that depicts a rotary image receiving member in the form of an intermediate transfer drum 16 having axis 15 and a translatable print bar 12 that is mounted adjacent and parallel thereto. As discussed later with respect to FIG. 7, an alternate embodiment of the application is shown as ink jet printer 52. Printer 52 has an image receiving member that is a cylindrical member or drum 53 on which a recording medium 21 may be temporarily wrapped around and held for direct printing thereon. The recording medium 21 is removed from the cylindrical member 53 by a stripper finger 39 after the required number of passes of the cylindrical member to complete the printed image.

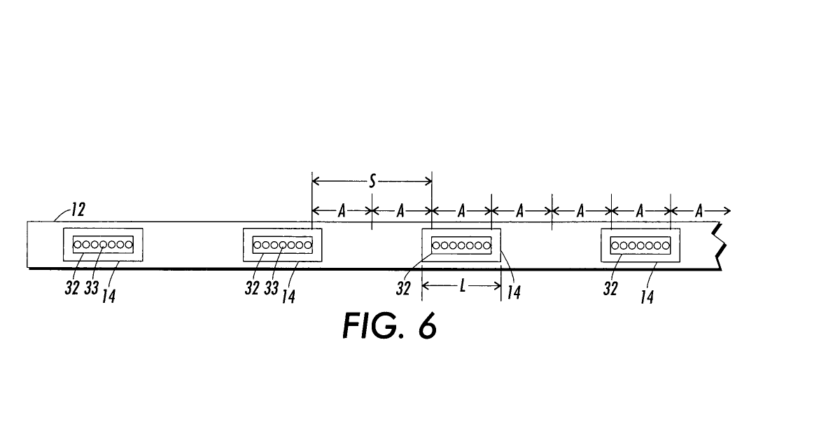

With continued reference to FIG. 1, in which one exemplary embodiment of this application is shown, the print bar 12 is translated in a direction parallel to the axis 15 of the intermediate transfer drum. A plurality of print heads 14 is mounted on the print bar. The print heads 14 are equally but sparsely spaced along the length of a print bar 12. The print bar and sparsely spaced print heads thereon are under control of the controller 24. The print heads 14 are identical to each other and comprise only a body or die having ink flow directing channels (not shown), ink droplet ejecting piezoelectric devices (not shown), and an array 32 (shown in FIG. 6) of droplet ejecting nozzles 33 that are connected to the channels. The nozzle arrays 32 have a nozzle density of about 400 to 450 nozzles per inch and a predetermined nozzle array length “A” that extends for a distance of about 150 to 200 mils. The ink distribution system (not shown) for the print heads 14 from an ink supply 51 and the electrical driving circuitry (not shown) for the print heads may be positioned any where along the print bar 12. As a result, under control of the controller 24, each of the print heads 14 on the print bar 12 confronting the intermediate transfer drum 16 may selectively eject ink droplets from the nozzles 33 of their respective nozzle arrays 32 onto the intermediate transfer drum 16.

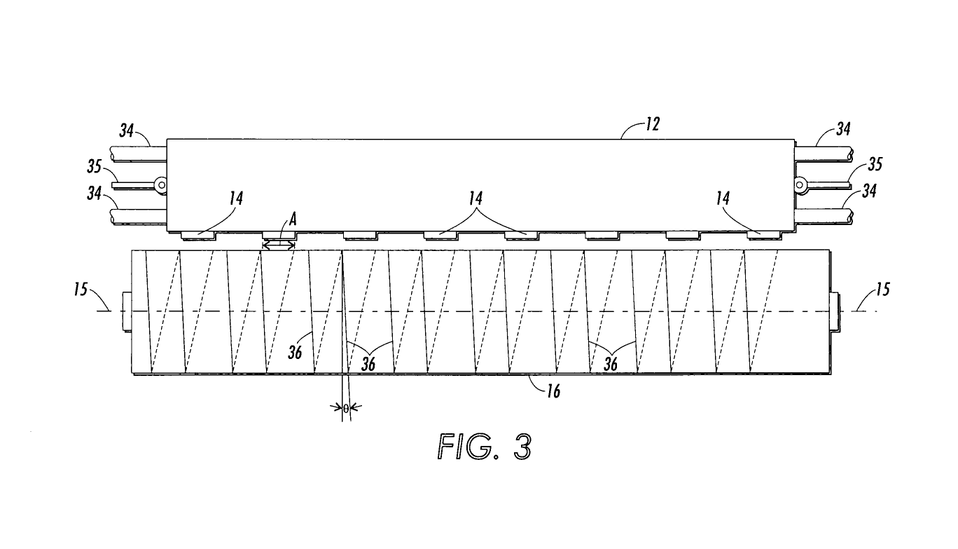

While the print heads 14 on the print bar 12 are printing, the print bar is concurrently translated a small distance during each revolution of the intermediate transfer drum 16. The translation range of the print bar during one rotation of the intermediate transfer drum is from an integer divisor of the nozzle array length A to a complete length A of one nozzle array. If less than a nozzle array length is used for the print bar translation during one revolution of the intermediate transfer drum, more passes or revolutions would be required of the intermediate transfer drum 16 to complete an image thereon. However, a translation of less than one nozzle array length by the print bar 12 per revolution of the intermediate transfer drum 16 would proportionally increase the printing resolution by providing more spots or lines per inch. For example, if a plurality of print heads, each having a nozzle array length of 0.1 inches, is spaced along a print bar with a spacing of two nozzle array lengths (0.2 inches) between nozzle arrays that have a density of 400 nozzles per inch, then the image would be completely printed in three passes with a resolution of 400 spi, when the print bar is translated 0.1 inches (one nozzle array length) during each revolution of the intermediate transfer drum. However, if this print bar is translated only 0.05 inches (a nozzle array length integer divisor of 2) during each revolution of the intermediate transfer drum, the image would be completely printed in six passes with a resolution of 800 spi. The translation of the print bar 12, while the print heads 14 thereon are printing on a rotating intermediate transfer drum 16, produces the images printed thereon in the form of barber pole shaped swaths 36 of ink images (see FIG. 3). Each swath 36 would have a width approximately equal to the translation distance traveled by the print bar 12 during each intermediate transfer drum 16 revolution. The print heads each receive an ink ejection signal from the controller 24 and, in response thereto, eject ink droplets onto the intermediate transfer drum. Ink droplets are ejected during each revolution of the intermediate transfer drum until the whole image is formed thereon. While ink droplets are being deposited on the intermediate drum, the transfixing roll 17 at the transfixing station 18 is not in contact with the intermediate transfer drum.

As shown in FIG. 3, a swath 36 of the image is deposited by each of the print heads 14 on the print bar 12 during a first rotation of the intermediate transfer drum 16. Since the print bar is translated concurrently with the rotation of the intermediate transfer drum for a distance equal to the length A of a nozzle array, the swaths 36 of the image that are printed will be wrapped around the outer surface of the intermediate transfer drum in a barber pole fashion. Then, during one or more subsequent rotations of the intermediate transfer drum, under control of the controller 24 and associated memory 26, the print heads on the print bar deposit the remaining contiguous barber pole swaths of image on the intermediate transfer drum to complete the printed image.

Referring again to FIG. 1, when a complete image has been printed on the intermediate drum 16 in barber pole fashion, under control of the controller 24 and associated memory 26, the exemplary ink jet printer 10 converts to a printer configuration for transferring and fixing the printed image to a recording medium 21 at the transfixing station 18. According to this configuration, the transfixing roll 17 at transfixing station 18 is moved from a spaced location toward the intermediate transfer drum 16 in the direction of arrow 25 to form the transfixing nip 19. A sheet of recording medium 21 is transported by transport 22, under control of the controller 24, to the transfixing station 18 and then through a nip 19, as indicated by arrow 26. The transfixing roll 17 applies pressure against the back side of the recording medium 21 in order to press the front side of the recording medium against the intermediate transfer drum. Although the transfixing roll 17 may also be heated, in this exemplary embodiment, it is not. Instead, the transport 22 contains a pair of pre-heating rolls 23 for the recording medium 21. The pre-heating rolls 23 provide the necessary heat to the recording medium 21 for subsequent aid in transfixing the image thereto, thus simplifying the design of the transfixing roll 17. The pressure created by the transfixing roll 17 on the back side of the heated recording medium 21 facilitates the transfixing (transfer and fusing) of the image from the intermediate transfer drum 16 onto the recording medium 21.

The rotation or rolling of both the intermediate transfer drum 16 and transfixing roll 17, as shown by arrows 27,28 respectively, not only transfix the images onto the recording medium, but also assist in transporting the recording medium through the nip 19 formed between them. This transporting assistance by the rolling intermediate transfer drum 16 and transfixing roll 17 is especially needed after the trailing edge of the recording medium 21 leaves the recording medium transport 22.

Once an image is transferred from the intermediate transfer drum 16 and transfixed to a recording medium 21, the transfixing roll 17 is moved away from the intermediate transfer drum and the intermediate transfer drum continues to rotate. Under the control of the controller 24, any residual ink left on the intermediate transfer drum is removed by well-known drum maintenance procedures at a maintenance station, not shown. Also, periodic applications of release agent (not shown), such as, for example, silicone oil, are applied to the surface of the intermediate transfer drum by the release agent applicator 20, under control of the controller 24, prior to subsequent printing of images on the intermediate transfer drum by the print heads 14 on print bar 12. Typically, the release agent applicator 20 includes a container 29 of release agent (not shown) and a resilient porous roll 30 rotatably mounted in the container and in contact with the release agent. The porous roll 30 is periodically moved into and out of temporary contact With the rotating intermediate drum to coat the surface thereof as needed by the controller 24, as indicated by arrow 31.

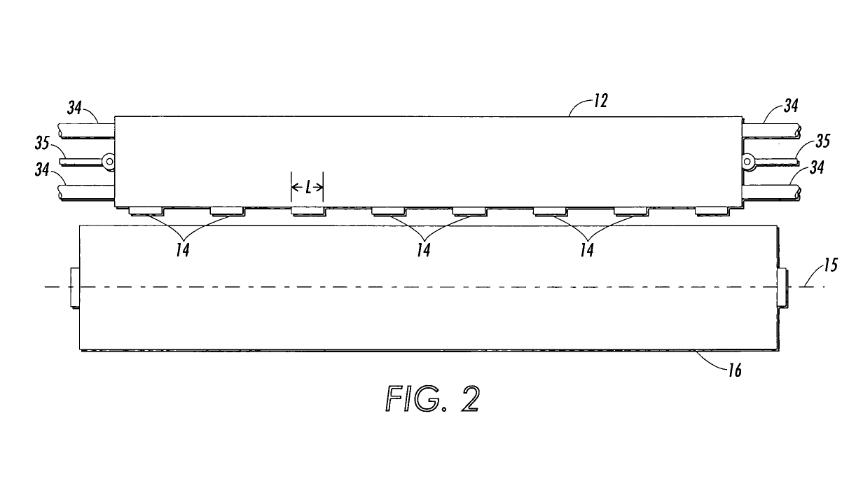

In FIG. 2, a partially shown top view of FIG. 1 is depicted that shows the location of the equally spaced print heads 14 on the print bar 12 relative to the intermediate transfer drum 16 prior to initiation of printing by the printer 10. The print heads may be any suitable small identical ink droplet ejecting dies, such as, for example, MEMS devices, that have piezoelectric droplet ejecting devices (not shown) for ejecting ink droplets from the print heads. Referring also to FIG. 6, each print head 14 has a length “L” of about 0.10 to 0.25 inches and preferably about 0.16 inches or 160 mils. Each print head 14 has a nozzle array 32 extending for a distance “A” that is slightly less than the print head length or about 0.15 inches or 150 mils. The nozzle arrays 32 have nozzles 33 that are of a size and density, so that they are capable of printing 400 to 450 spots or lines per inch. The print heads 14 are accurately mounted on the print bar 12 with a spacing “S” between each other's nozzle array by multiples of the length “A” of the nozzle arrays 32. The print head spacing is shown as two nozzle array lengths between nozzle arrays, but could be one nozzle array length or three or more nozzle array lengths. In this configuration, there is no need to dice off the ends of the print heads as would be required for full width print heads produced by end-to-end abutting of dies or MEMS devices.

The print bar 12, sparsely populated with print heads 14, is shown with the print heads aligned in a single row. The print heads 14 could also be staggered rather than being in a single row along the length of the print bar 12. The spacing between the print heads 14 shown in FIG. 2, of course, determine the length of the print bar 12, so that a completely printed image can be printed on the rotating intermediate transfer drum 16 by the print bar during one continuous translating movement thereof. Thus, in this example, the print bar 12 travels a total distance three nozzle array lengths A, one nozzle array length per revolution of the intermediate transfer drum 16, while the intermediate transfer drum makes three revolutions past the print bar for a complete image to be printed.

FIGS. 3 through 5 show the translation of the print bar 12 as moving the distance of one nozzle array length A per revolution of the intermediate transfer drum 16. However, the print bar 12 may translate in the range of from an integer divisor of the nozzle array length A or number of nozzles in the nozzle array to one complete nozzle array length. Of course, when the print bar translation per intermediate transfer drum revolution is less than one nozzle array length, more passes by the intermediate transfer drum are required to complete the printing of the image thereon.

In FIG. 3, the length of the translating advance of the print bar 12 is preferably a short distance, for example, less than 0.5 cm, so that the angle θ of the barber pole shaped swath is small with respect to the process direction. The process direction is a direction perpendicular to the axis of the intermediate transfer drum as indicated by arrow 27 in FIG. 1. For example, the length of translating advance of the print bar 12 is preferably less than 0.5 cm, so that the printed lines in the process direction do not suffer from excessive “stair stepping.” Accordingly, nozzle array lengths should preferably also be less than 0.5 cm.

The print bar 12 of FIG. 2 is translatable in a direction parallel to the axis 15 of the intermediate transfer drum 16 by any suitable means. For example, the print bar 12 could translated by mounting the print bar on guide rails 34 and translating the print bar along the guide rails 34 by a cable 35 attached to each end of the print bar. The cable 35 could be installed over two or more pulleys (not shown). One of the pulleys would be driven by an electric motor (not shown) that is controlled by the controller and a typical program stored in the memory 26.

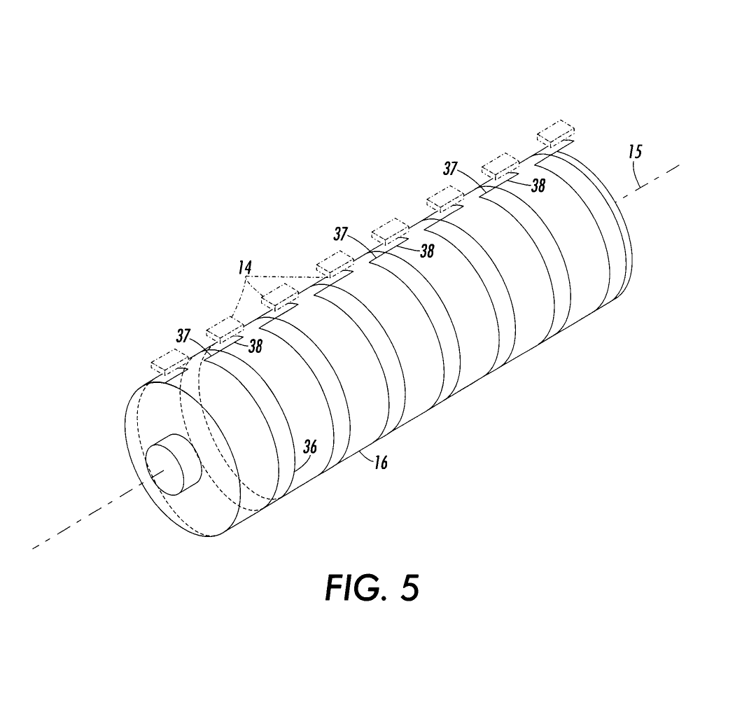

FIG. 3 is similar to FIG. 2, but shows the translation of the print bar 12 for the distance of a nozzle array length A and the printing of one swath 36 of information by each print head 14. The swaths 36 of information are wrapped around the outer surface of the intermediate transfer drum in barber pole fashion. In this view, the back half of the swaths 36 that are not visible are shown in dashed line. In FIG. 5, an isometric view of the intermediate transfer drum 16 is shown with the first swaths 36 of information printed thereon. In this FIG. 5, the beginning end 37 of the swath 36 and end 38 of the printed barber pole shaped swaths are aligned with each other but off set by the distance of one nozzle array or swath width. The locations of the print heads 14 are shown in dashed lines above the swath ends 38 after the completion of one revolution of the intermediate transfer drum.

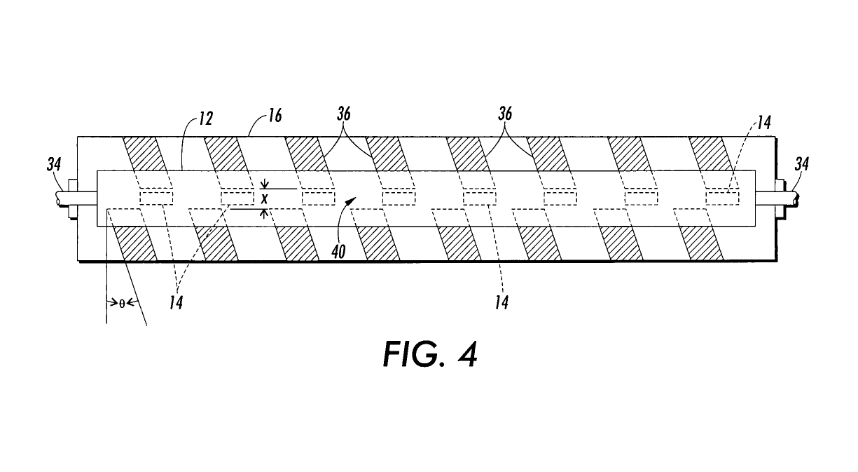

In FIG. 4, a partially shown back view of the printer 10, is depicted as viewed along view line 4-4 in FIG. 1. This FIG. 4 also shows one barber pole shaped swath 36 of information printed on the rotating intermediate transfer drum 16 by each print head 14 on the translating print bar 12, after one revolution of the intermediate transfer drum 16. The print heads are shown in dashed line adjacent the ends 38 of the barber pole shaped swaths 36. However, in this alternate embodiment, the swath beginning end 37 and swath final end 38 of each of the swaths 36 are not only off set from each other by the translating advance of the print bar 12, but also are spaced from each other. This spacing from the beginning ends 37 from the swath ends 38 provide an inter-document space or zone 40, as indicated by the distance “X.” The inter-document space 40 may be utilized for many purposes, such as, for example, a location to check for nozzle failures. Another use for the inter-document zone 40 would be to enable a discrete, very short movement of the print bar 12 at the end of each revolution of the intermediate transfer drum 16, whenever the end 38 of swath 36 is not exactly as required. Thus, within the inter-document zone 40, the combination of intermediate transfer drum rotation and a very short translating advance of the print bar, as controlled by the controller 24 in corporation with a program in the memory 26, could adjust the location of the subsequent beginning end 37 of swath 36. This would require, for example, using an integer divisor of the nozzle array length for the extra very short advance of the print bar while in the inter-document zone 40.

Modern solid ink print head designs, such as, for example, MEMS devices, are able to pack more and more droplet ejecting nozzles in their nozzle arrays, leading to high spi densities and higher productivity printing. However, a difficulty is encountered when trying to take advantage of this high pixel density in an office class printer. The large increase in the number of nozzles in a full width array print head also increases the likelihood of nozzle failure, so reliability decreases and, of course, the huge increase in print head cost makes a full width array print head with high nozzle density less desirable. This forces the compromise of either using partial width print heads having high density nozzle arrays in the office class printer, and thus suffer the loss of printing productivity during stepping of the partial width print head as well as the acceleration/deceleration time loss inefficiencies, or continuing to use low density nozzle arrays for full width array print heads in the office class printer.

In FIG. 7, a schematic, side elevation view of an alternate embodiment of the ink jet printer 10 in FIG. 1 is shown as ink jet printer 52. This ink jet printer 52 includes, in part, a printer controller 24 and memory 26, a translatable print bar 12 with a plurality of equally space print heads 14 thereon, and a rotary image receiving member in the form of a rotatable cylindrical member or drum 53. A recording medium 21 is temporarily attached to the cylindrical drum 53 for direct printing thereon by the print heads 14. As described above, the print heads 14 have an array 32 of nozzles 33. The nozzle array 32 has a predetermined length A of about 0.15 inches or 150 mils. The print heads 14 are also spaced from each other's nozzle array by an integer multiple of the nozzle array length A. A paper supply tray 11 has a stack of recording medium 21 thereon, such as, for example, paper, and a sheet feeding roll 13 for feeding the recording medium seriatim from the supply tray 11 to a transport system 55. The transport system 55 has a transport guide 42 and a transport roller 43 for transporting and directing each recording medium 21 onto the cylindrical drum 53.

The recording medium 21 is wrapped around and held onto the outer surface of the cylindrical drum 53 by any suitable means (not shown), such as, for example, by electrostatic attraction or by a vacuum. As described with reference to FIG. 1, the print bar 12 of printer 52 has sparsely spaced print heads 14 thereon and functions in substantially the same way. Under control of the controller 24, the print bar 12 is translated parallel to the cylindrical drum axis 54 for a distance from an integer divisor of the nozzle array length A (or number of nozzles in the array) to one complete length of a nozzle array during each revolution of the cylindrical drum 53. Each print head 14 prints a barber pole shaped swath 36 of information directly on the recording medium 21 on the cylindrical drum 53. After the required number of passes of the cylindrical drum 53 to complete the printed image, the recording medium with the image printed thereon is removed by a pivoting stripper finger 39 that is controlled by the controller 24. After being stripped by the stripper finger 39, the recording medium 21 with the printed image is placed in a collection tray 41.

In the same manner as in ink jet printer 10,, the ink supply 51 is connected to an ink distribution system (not shown) on the print bar 12. The ink distribution system and electrical drive circuitry (not shown) are located at any convenient place on the print bar 12. Each of the print heads 14, as discussed above, is only a die or body containing ink flow channels with associated piezoelectric devices and the array of nozzles connected to the channels. The main difference between ink jet printer 52 and ink jet printer 10 is that the print heads 14 of printer 52 print images directly on a recording medium 21 attached to the cylindrical drum 53, while the print heads 14 of ink jet printer 10 print images on the intermediate transfer drum 16 and the images must subsequently be transferred to a recording medium 21.

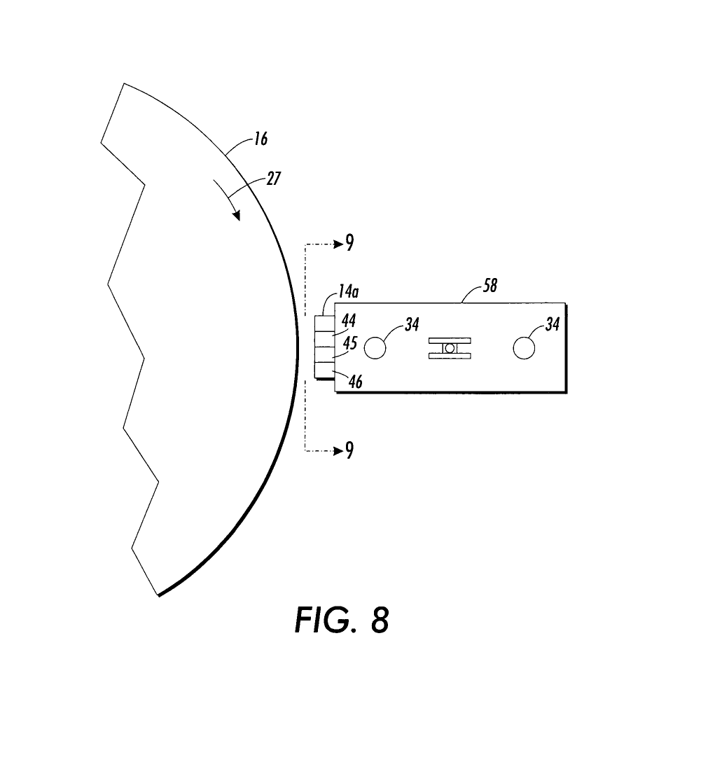

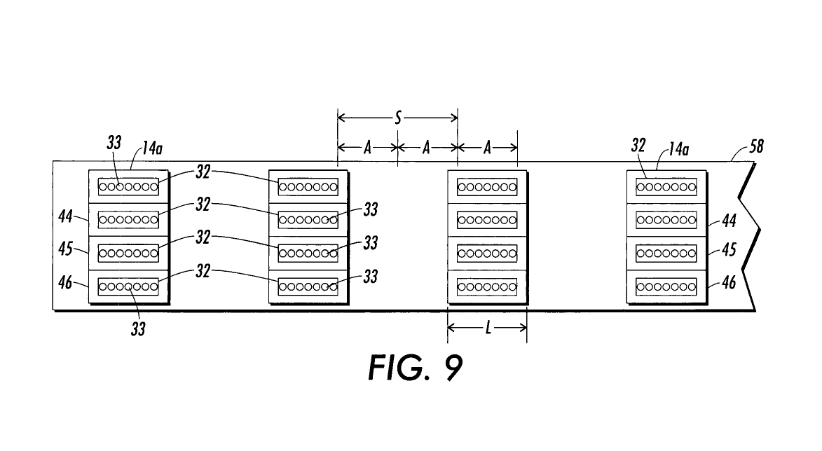

In FIGS. 8 and 9, a partially shown schematic, side elevation view of the ink jet printer 10 of FIG. 1 is shown having an alternate print bar embodiment as print bar 58. Print bar 58 has a column of identical print heads 14a, 44, 45, and 46 in place of the single print heads 14 in printer 10, one print head for each color of ink. This embodiment of print bar 58 would be useful where print heads are inherently only for printing in a single color and a multicolor system is desired. As shown in FIGS. 8 and 9, a series of sequential print heads are aligned in a column in the process direction, as indicated by arrow 27. A first row of print heads 14a are sparsely mounted on the print bar 58 in the same manner as described above with respect to print bar 12. The print heads 14a may print any color, such as, for example, black. Directly beneath and adjacent print heads 14a, print heads 44 are mounted for printing a different color of ink, such as, magenta. Print heads 45 are aligned with print heads 14a and 44 and mounted adjacent print head 44. Print heads 45 would print a different color, such as, yellow. The last print heads 46 would be aligned with the previously mounted print heads 14a, 44, and 45 and mounted below print head 45. Print heads 46 would print still another color, such as, cyan. Each of the print heads 14a, 44, 45, 46 are identical and have the same nozzle arrays 32 and same nozzles 33 as described with respect to the print bar 12. Thus, as the intermediate transfer drum 16 rotates past the translating print bar 58, the print heads would sequentially print their color portion of the multicolored barber pole shaped swaths 36 of the multicolor image on the intermediate transfer drum 16.

In summary, the exemplary embodiment of this application solves the above-described dilemma of meeting cost requirements of the office printer with desired higher printing resolutions by taking advantage of the capabilities of the high density nozzle array print heads, based, for example, on the MEMS technology. In the exemplary embodiment, a full width print head is formed by sparsely populating a print bar with small identical, high nozzle density print heads that are spaced apart by multiples of the length of the print head's nozzle array. The print bar is moved a distance in the range of an integer divisor of the nozzle array length up to one whole nozzle array length (or printed swath width) during each revolution of the intermediate transfer drum. Thus, each print head 14 on the print bar 12 prints a swath 36 of information on the intermediate transfer drum 16 in a barber pole fashion. The number of passes of the rotatable intermediate transfer drum 16 required to print a complete image thereon is determined by the spacing of the print heads 14 and the amount of print bar 12 advance.

By sparsely populating the high density print heads, such as MEMS devices, on a full width print bar, the print bar would act in many respects just as a conventional low density full width print bar, but would offer higher printing productivities. Accordingly, the goal of the exemplary embodiment is achieved by providing a low cost, high efficiency, high-density printing printer having a low complexity barber pole multipass architecture. In addition, such an exemplary embodiment of a print bar could potentially be used for retrofitting into existing office class printers, thereby upgrading those printers from low resolution printers to high resolution printers.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. a method of printing by an ink jet printer having a print bar with spaced: print heads, comprising:
providing an imaging receiving drum having an axis;
providing an elongated print bar adjacent said drum and parallel to said drum axis;
spacing a plurality of high resolution print heads along said print bar, said print heads being identical and equally spaced from each other, each of said print heads having an array of droplet ejecting nozzles that confronts said drum and extends for a predetermined length, said print head spacing being integer multiples of a distance equal to said nozzle array length as measured between adjacent nozzle arrays;
rotating said drum about said drum axis past said print bar;
translating said elongated print bar in a direction parallel to said drum axis and at a speed that moves said print bar a distance selected from a range between integer divisors of said nozzle array length to at most a distance equal to one nozzle array length during each revolution of said drum; and
ejecting ink droplets from said print heads on said translating print bar onto said rotating drum, thereby printing swaths of information on said drum in a barber pole fashion during each revolution of said drum.

2. The method as claimed in claim 1, wherein said step of rotating said drum past said print bar is continued until an adequate number of passes of said drum enables completion of the required number of said swaths to complete the printed information.

3. The method as claimed in claim 2, wherein at said step of translating said print bar, said print bar is translated in one continuous movement during said adequate number of passes of said drum required to complete said printed information.

4. The method as claimed in claim 3, wherein said high resolution print heads are capable of printing 400 to 450 spots per inch; and wherein said predetermined length of said array of nozzles is less than 0.5 cm, so that an angle θ of the barber pole shaped swath of printed information relative to the printing process direction is small, thereby preventing excessive stair stepping edges of said printed swaths.

5. The method as claimed in claim 3, wherein each of said printed swaths of information have a beginning end and a final end; wherein said swath beginning end and final end are spaced apart on said image receiving drum to form an inter-document zone; and wherein the beginning ends of subsequently printed swaths may be adjusted on said image receiving drum during a time period in which said print bar is in said inter-document zone.

6. The method as claimed in claim 3, wherein said image receiving drum is an intermediate transfer drum.

7. The method as claimed in claim 6, wherein said method further comprises:
providing a transfixing station having a movable transfixing roller;
moving said transfixing roller into contact with said intermediate transfer drum to form a transfixing nip after printing of said information; and
transporting a recording medium through said transfixing nip to transfer and fix said printed information on said intermediate transfer drum to said recording medium.

8. The method as claimed in claim 3, wherein said image receiving drum is capable of holding a recording medium thereon; and wherein the method further comprises:
placing said recording medium around said drum, so that said print heads on said print bar print said swaths of information directly on said recording medium.

9. The method as claimed in claim 8, wherein said further comprises:
actuating a stripper finger to remove said recording medium from said drum after said information has been printed thereon.

10. The method as claimed in claim 3, wherein said print bar has multiple spaced columns of sequentially placed adjacent print heads, each print head in said column of print heads prints a different color, so that said print heads sequentially print their color portion of said barber pole shaped swath of multicolor information.

11. An ink jet printer, comprising:
a rotatable image receiving drum having an axis;
a translatable, elongated print bar mounted adjacent said drum and parallel to said drum axis;
a plurality of high resolution print heads being equally spaced along said print bar, each of said print heads having an array of droplet ejecting nozzles that extend for a predetermined length, said print head spacing being an integer multiple of said predetermined nozzle array length as measured between said nozzle arrays;
a controller for concurrently causing said drum to rotate about said drum axis and said print bar to translate in a direction parallel to said drum axis, said print heads on said print bar ejecting ink droplets onto said rotating drum as said print bar is being translated a distance selected from a range between integer divisors of said nozzle array length to at most a distance equal to said predetermined nozzle array length during each revolution of said drum, so that each of said print heads print barber pole shaped swaths of information on said drum during each revolution of said drum; and
said print head spacing and print bar translation distance per drum revolution determining the number of drum revolutions required to complete printing of said information on said drum.

12. The ink jet printer as claimed in claim 11, wherein said image receiving drum is an intermediate transfer drum, and wherein said intermediate transfer drum is rotated past said print bar an adequate number of times to complete printing of said information thereon.

13. The ink jet printer as claimed in claim 12, wherein said translation by said print bar is one continuous movement during the adequate number of passes by said rotating intermediate transfer drum.

14. The ink jet printer as claimed in claim 13, wherein the printer further comprises:
a transfixing station having a movable transfixing roller that forms a transfixing nip with said intermediate transfer drum after all of said information has been printed on said intermediate transfer drum; and
a recording medium transport to deliver said recording medium through said transfixing nip to transfer and fix said information to said recording medium from said intermediate transfer drum.

15. The ink jet printer as claimed in claim 11, wherein said image receiving drum has an outer surface and is capable of holding a recording medium thereon; and wherein said printer further comprises:
a transport system for transporting said recording medium onto said drum surface, so that said print heads on said print bar print said barber pole shaped swaths of information directly on said recording medium.

16. The ink jet printer as claimed in claim 15, wherein said printer further comprises:
a pivoting stripper finger operative to remove said recording medium from said drum after said information has been printed thereon.

17. The ink jet printer as claimed in claim 11, wherein said high resolution print heads are capable of printing 400 to 450 spots per inch; and wherein said predetermined length of said array of nozzles is less than 0.5 cm, so that an angle θ formed between an edge said barber pole shaped swaths of information and the direction of rotation of said image receiving drum is small, thereby preventing excessive stair stepping at edges of said printed swaths.

18. The ink jet printer as claimed in claim 11, wherein said printed swaths of information have a beginning end and a final end; wherein said swath beginning end final end are spaced apart on said image receiving drum to form an inter-document zone; and wherein the beginning end of a subsequently printed swath may be adjusted on said image receiving drum during a time period in which said print bar is in said inter-document zone.

19. The ink jet printer as claimed in claim 11, wherein said print bar has a plurality of identical columns of adjacent high resolution print heads equally spaced therealong, each print head in said column of print heads prints a different color, so that said print heads in said columns of print heads sequentially print their color portion of said respective barber pole shaped swaths of multicolored information.

20. A method of printing by an ink jet printer having a print bar with print heads thereon, comprising:
providing a rotatable cylindrical image receiving surface having an axis;
providing a translatable elongated print bar adjacent said image receiving surface and parallel thereto;
mounting at least one parallel row of high resolution print heads along said print bar, each of said print heads being identical and having an array of droplet ejecting nozzles that extend for a predetermined length in a direction parallel to said image receiving surface;
spacing said print heads in said at least one row from each other by a distance equal to one or more integer multiples of said nozzle array length, said print head spacing being measured between respective nozzle arrays;
rotating said image receiving surface about said axis thereof;
translating said print bar in a direction parallel to said image receiving surface and at a speed that moves said print bar a distance selected from a range between integer divisors of said nozzle array length to at most a distance equal to one nozzle array length during each revolution of said image receiving surface; and
ejecting ink droplets from said nozzle arrays of said print heads during concurrent rotation of said image receiving surface and translation of said print bar to print barber pole shaped swaths of information on said image receiving surface during each revolution thereof.
